(19) United States
(12) Patent Application Publication
(10) Pub. No.: US 2026/0109419 A1
(43) Pub. Date: Apr. 23, 2026

(54) MOBILE BIPEDAL ROBOT

(71) Applicant: United States of America as represented by the Administrator of NASA, Washington, DC (US)

(72) Inventors: Kenneth Chun-Wai CHEUNG, MOFFETT FIELD, CA (US); Christine E. GREGG, MOFFETT FIELD, CA (US); Olivia Irene B. FORMOSO, MOFFETT FIELD, CA (US); Greenfield Tran TRINH, MOFFETT FIELD, CA (US); In-Won PARK, MOFFETT FIELD, CA (US); Megan E. OCHALEK, MOFFETT FIELD, CA (US); Damiana CATANOSO, MOFFETT FIELD, CA (US); Arno ROGG, MOFFETT FIELD, CA (US)

(21) Appl. No.: 18/886,984

(22) Filed: Sep. 16, 2024

Related U.S. Application Data
(60) Provisional application No. 63/582,838, filed on Sep. 14, 2023.

(51) Int. Cl. B62D 57/032; B25J 9/16; B25J 15/02; B25J 17/02

(52) U.S. Cl. CPC B62D 57/032; B25J 9/1612; B25J 15/0206; B25J 17/0241

(57) ABSTRACT

A mobile bipedal robot is configured to carry, transfer and place 3D-lattice unit cells, such as voxels, to form a 3D-lattice structure. The mobile bipedal robot may provide transportation and placement of the voxels. A team of the mobile bipedal robots may autonomously unpack and assembly 3D-lattice unit cells into functioning structures and systems. The mobile bipedal robots may live and locomote on the 3D-lattice structure to monitor the health and performance of the 3D-lattice structure and make repairs and reconfigurations when necessary. Each mobile bipedal robot may have a specific function or role, such as a cargo transport robot or a crane robot. The cargo transport robot and the crane robot work together to move the voxels from one location to another. Each robot includes at least one electronic control module that receives commands from a central control system.

### CROSS-REFERENCES TO RELATED PATENT APPLICATIONS

This application claims priority to U.S. Provisional Application No. 63/582,838, filed Sep. 14, 2023, the entirety of which is incorporated by reference as if fully set forth herein.

### FIELD OF THE INVENTION

The present invention relates to a mobile bipedal robot.

### BACKGROUND

Missions to the moon and other planets will require autonomous assembly of low-mass, high-precision and large-scale infrastructure and hardware systems in a variety of technical fields including, but not limited to, solar power, communications, habitats and scientific instruments. Conventional methodologies for constructing such infrastructure and hardware are poorly suited for missions to other planets due to the mass, size and weight limitations and the high projected costs of attempting to implement such methodologies on other planets.

What is needed is a novel and efficient system and method to construct low-mass, high-precision and large-scale infrastructure and hardware systems on other planets which resolves and eliminates the problems and issues associated with conventional methodologies.

### SUMMARY

A summary of certain embodiments disclosed herein is set forth below. It should be understood that these aspects are presented merely to provide the reader with a brief summary of these certain embodiments and are not intended to limit the scope of this disclosure or the claimed subject matter. Indeed, this disclosure may encompass a variety of aspects that may not be set forth below.

In accordance with an aspect of the present disclosure, there is provided a mobile bipedal robot comprising a knee joint module having a drive system configured to receive control signals. The mobile bipedal robot includes a pair of leg members comprising a first leg member and a second leg member. Each leg member has a first end portion joined to the knee joint module and an opposite second end portion. The knee joint module is configured to allow movement of the leg members in accordance with a single degree of freedom as a pitch rotation. The drive system of the knee joint module is configured to receive control signals that prompt the drive system to raise, lower, extend or contract the leg members. The mobile bipedal robot further includes a first ankle joint module joined to an opposite second end portion of the first leg member and a first ankle section having a first end portion joined to the first ankle joint module and an opposite second end portion. The first ankle joint module is configured to allow movement of the first ankle section in accordance with a single degree of freedom as a pitch rotation and includes a drive system configured to receive control signals that prompt the drive system of the first ankle joint module to raise and lower the first ankle section. The mobile bipedal robot further comprises a second ankle joint module joined to an opposite second end portion of the second leg member and a second ankle section having a first end portion joined to the second ankle joint module and an opposite second end portion. The second ankle joint module is configured to allow movement of the second ankle section in accordance with a single degree of freedom as a pitch rotation and further includes a drive system configured to receive control signals that prompt the drive system of the second ankle joint module to raise and lower the second ankle section. The mobile bipedal robot further comprises a pair of foot modules. Each foot module is joined to a corresponding one of the ankle sections and comprises an alignment member configured to passively self-align itself upon a 3D-lattice unit cell, at least one gripper device attached to the alignment member and configured to receive control signals that prompt the gripper device to grasp the 3D-lattice unit cell, and a yaw rotation mechanism mounted to the alignment member and having a yaw rotatable member that is configured for yaw rotation. The yaw rotatable member is joined to a corresponding one of the ankle sections. The yaw rotation mechanism includes a yaw drive device that is engaged with the yaw rotatable member and configured to receive control signals that prompt the yaw drive device to rotate the yaw rotatable member. An electronic control module is mounted to one of the leg members and is configured for generating the control signals for controlling the gripper devices and yaw drive devices and the drive systems of the knee joint modules and the ankle joint modules.

In accordance with another aspect of the present disclosure, there is provided a team of the mobile bipedal robots that work together to carry, transfer and place 3D-lattice unit cells to form a 3D-lattice structure. The team of bipedal robots provide transportation and placement of the voxels. The team of mobile bipedal robots autonomously unpacks and assembles structural unit cells (e.g., voxel) into functioning structures and systems. The team of mobile bipedal robots then lives (i.e., remain for extended or undetermined lengths of time) and locomotes on the 3D-lattice structure to monitor the health and performance of the 3D-lattice structure, enabling repair and reconfiguration when desired. The mobile bipedal robots work together in different roles, one as a cargo transport robot and the other as a crane robot. The cargo transport robot and the crane robot work together to move the voxels from one location to another. Each robot includes at least one electronic control module that receives commands from a central control system. The central control system comprises a microprocessor or other central processing unit (CPU) that is programmed to implement a plan to control the motion sequences of the robots to maximize efficiency and to optimize the work required to completely assemble a structure. The plan is pre-computed or computed during implementation by the central control system according to a path planning algorithm that utilizes the regularity of the 3D-lattice structure to simplify path planning, align robotic motions with minimal feedback, and reduce the number of the degrees of freedom required for the robots to locomote across and throughout the 3D-lattice structure and assemble the 3D-lattice structure. All throughout the assembly process, the robots are constantly transmitting status signals for processing by each other and/or the central control system. In some embodiments, signal communication between the electronic control modules and the central control system is realized through telemetry.

### BRIEF DESCRIPTION OF THE DRAWINGS

FIG. 1 illustrates a side view of an exemplary embodiment of a mobile bipedal robot in accordance with the present disclosure;

FIG. 2A illustrates a top view of the mobile bipedal robot;

FIG. 2B is a top view of a support member that is part of the alignment member shown in FIGS. 1 and 2A;

FIG. 3 illustrates an exemplary embodiment of a knee joint module of the mobile bipedal robot;

FIG. 4 illustrates a partial, perspective view of the knee joint module and portions of the legs of the mobile bipedal robot that are engaged with the knee joint module;

FIG. 5 illustrates an exploded view of a yaw rotation mechanism in accordance with an exemplary embodiment of the present disclosure;

FIG. 6 illustrates an exemplary embodiment of an electronic control module that is mounted to the mobile bipedal robot and configured to provide control signals to components of the mobile bipedal robot;

FIG. 7 illustrates an exemplary embodiment of a central control system for providing command signals to the electronic control module;

FIGS. 8A-8G illustrate an exemplary gait of the mobile bipedal robot in accordance with embodiments of the present disclosure;

FIGS. 9A-9C illustrate another exemplary gait of the mobile bipedal robot in accordance with embodiments of the present disclosure;

FIG. 10 illustrates a team of identical mobile bipedal robots in accordance with embodiments of the present disclosure, wherein a first bipedal robot is using one of its foot modules to transfer a voxel to a second bipedal robot during the assembly of a 3D-lattice structure;

FIG. 11 illustrates a team of identical mobile bipedal robots in accordance with embodiments of the present disclosure, wherein a first mobile bipedal robot uses its cargo holder to transfer a voxel to a second mobile bipedal robot during the assembly of a 3D-lattice structure;

FIG. 12 illustrates a method of assembling a 3D-lattice structure using a team of mobile bipedal robots in accordance with an exemplary embodiment of the present disclosure; and

FIG. 13 illustrates a distributed control method for a build session wherein two mobile bipedal robots are positioned on the 3D-lattice structure in accordance with an exemplary embodiment of the present disclosure.

### DETAILED DESCRIPTION

Reference in the specification to “an exemplary embodiment”, “one embodiment” or “an embodiment” means that a particular feature, structure or characteristic described in connection with the embodiment is included in at least one embodiment of the invention. The appearances of the phrases “an exemplary embodiment”, “one embodiment” or “an embodiment” in various places in the specification are not necessarily all referring to the same embodiment.

As used herein, the terms “comprise”, “comprises”, “comprising”, “include”, “includes”, “including”, “has”, “having” or any other variation thereof, are intended to cover a non-exclusive inclusion. For example, a process, method, article or apparatus that comprises a list of elements is not necessarily limited to only those elements, but may include other elements not expressly listed or inherent to such process, method, article or apparatus.

As used in this document, the singular form “a”, “an” and “the” include plural references unless the context clearly dictates otherwise. Unless defined otherwise, all technical and scientific terms used herein have the same meanings as commonly understood by one of ordinary skill in the art.

In this document, when terms such as “first”, “second”, “third”, “fourth”, “fifth”, etc. are used to modify a noun, such use is simply intended to distinguish one item from another, and is not intended to require a sequential order unless specifically stated.

Approximating language, as used herein throughout the specification and claims, may be applied to modify any quantitative representation that could permissibly vary without resulting in a change in the basic function to which it is related. Accordingly, a value modified by a term such as “about” or “approximately” is not limited to the precise value specified.

The mobile bipedal robots disclosed herein are described in terms of handling, transporting, placing and fastening together 3D-lattice unit cells in order to form structures and hardware systems. One example of a 3D-lattice unit cell is a cuboctahedron voxel. Such a voxel is described in U.S. Pat. No. 11,498,250, issued Nov. 15, 2022 and entitled “Method for Discrete Assembly of Cuboctahedron Lattice Materials”. The disclosure of U.S. Pat. No. 11,498,250 is hereby incorporated by reference. For purposes of describing the mobile robots of the present disclosure, the ensuing description is in terms of the mobile robots working handling, transporting and placing voxels.

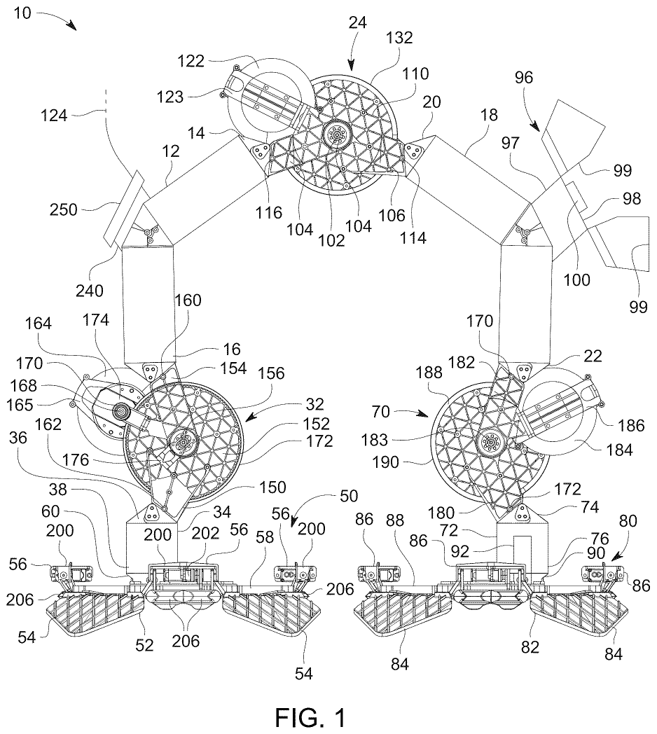

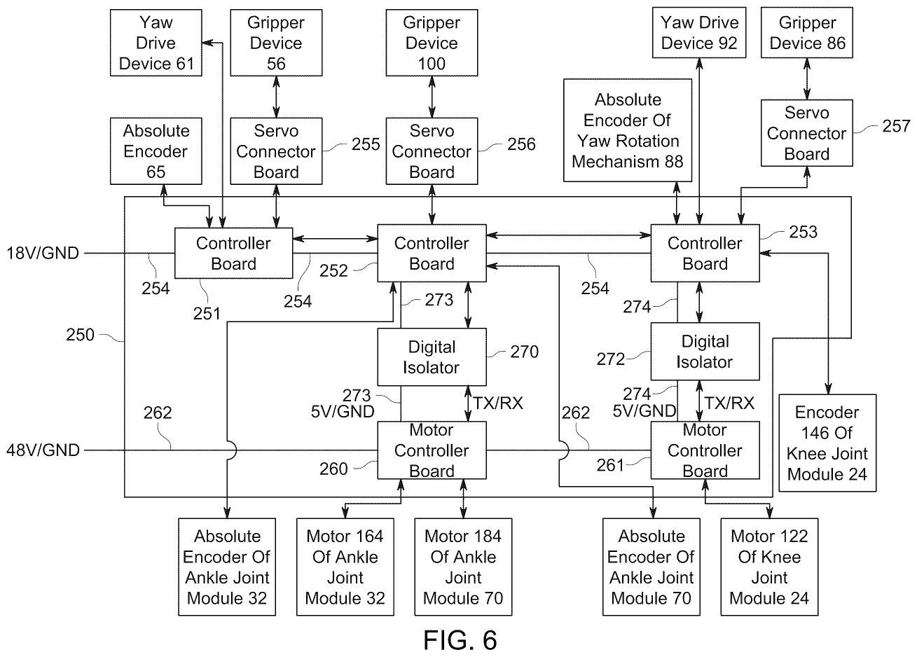

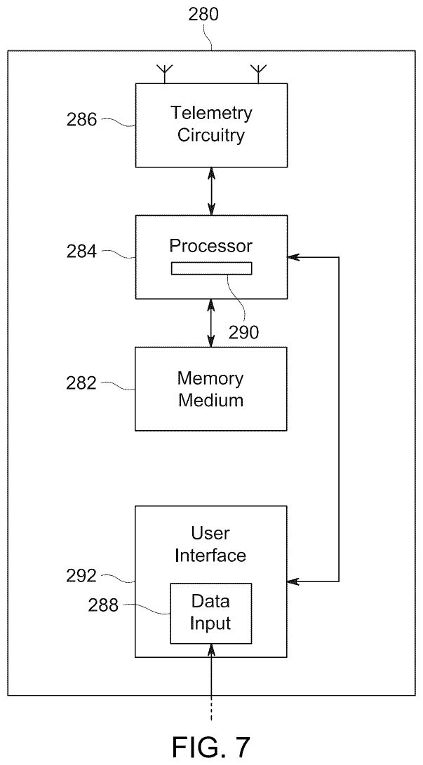

Referring to FIGS. 1-4, there is shown a mobile bipedal robot 10 in accordance with an exemplary embodiment of the present disclosure. Robot 10 comprises leg 12 that has first end portion 14 and opposite second end portion 16. Robot 10 further comprises leg 18 that has first end portion 20 and opposite second end portion 22. Robot 10 includes electronic control module 250 that is removably attached or mounted to one of the legs of robot 10. In this embodiment, electronic control module 250 is removably attached to adapter 240. Adapter 240 is removably attached to leg 12. Electronic control module 250 receives robotic-motion commands from central control system 280 (i.e., the base station). Embodiments of electronic control module 250 and central control system 280 are shown in FIG. 6 and FIG. 7, respectively, and are described in detail in the ensuing description. Robot 10 includes knee joint module 24 that is engaged with legs 12 and 18. Knee joint module 24 is configured to provide legs 12 and 18 with a single degree of freedom as a pitch rotation thereby allowing legs 12 and 18 to be raised and lowered. Knee joint module 24 includes a drive system that is configured to receive command signals from electronic control module 250 that prompt the drive system to raise and lower legs 12 and 18. An embodiment of the drive system of knee joint module 24 is described in detail in the ensuing description. Robot 10 includes ankle joint module 32 and ankle section 34. Ankle joint module 32 is attached to opposite second end portion 16 of leg 12. Ankle section 34 has a first end portion 36 and opposite second end portion 38. First end portion 36 is engaged with ankle joint module 32. Ankle joint module 32 is configured to provide ankle section 34 with a single degree of freedom as a pitch rotation that allows ankle section 34 to be raised and lowered. Ankle joint module 32 further comprises a drive system that is configured to raise and lower ankle section 34 upon receiving command signals from electronic control module 250. The drive system of ankle joint module 32 is identical to the drive system of knee joint module 24 in construction and configuration. The drive system of ankle joint module 32 is described in detail in the ensuing description.

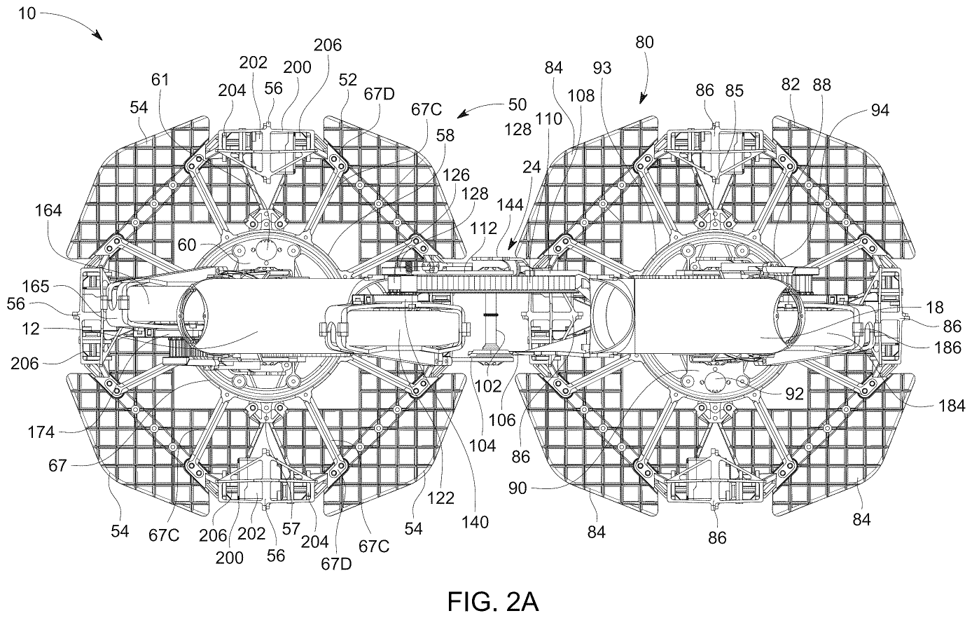

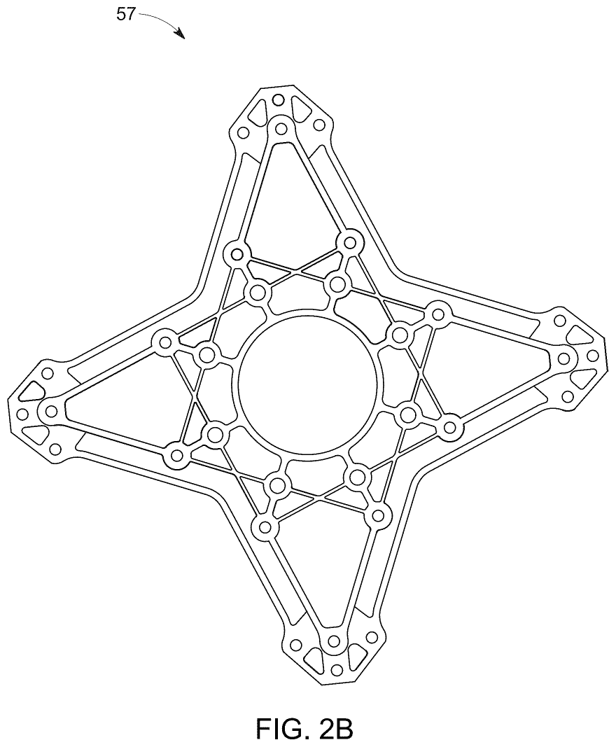

Referring to FIGS. 1, 2A, 2B and 3, robot 10 further comprises foot module 50 that is attached to opposite second end portion 38 of ankle section 34. Foot module 50 comprises alignment member 52 that comprises a plurality of petals 54 that are configured to allow alignment member 52 to passively self-align itself upon a voxel as first foot module 50 makes initial contact with the voxel. Foot module 50 further comprises a plurality of gripper devices 56 that are attached to alignment member 52. When alignment member 52 becomes positioned upon and aligned with a voxel, electronic control module 250 outputs control signals that control gripper devices 56 to grab onto the voxel. When it is time to release the voxel, electronic control module 250 issues command signals to gripper devices 56 that prompt the gripper devices 56 to release the voxel. In one embodiment, there are four gripper members 56 that are equidistantly spaced. The configuration of each gripper device 56 is described in detail in the ensuing description. Alignment member 52 further includes support member 57 that is attached to petals 54 so as to provide structural support and enhance structural integrity. A full view of support member 57 is shown in FIG. 2B.

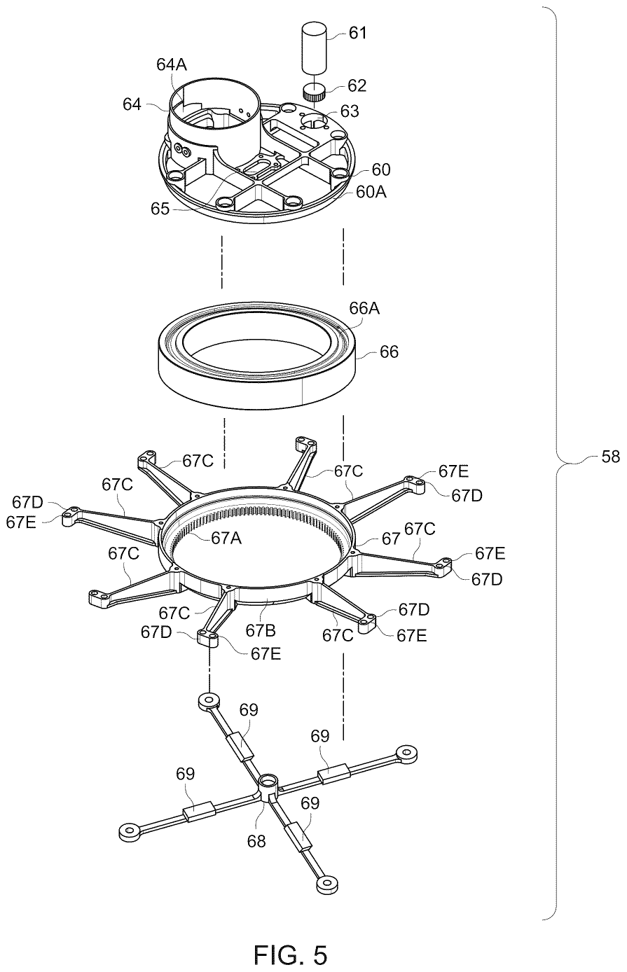

Referring to FIGS. 2A and 5, foot module 50 further comprises yaw rotation mechanism 58 that is attached to alignment member 52. Yaw rotation mechanism 58 comprises yaw rotatable member 60 that is configured for yaw rotation and is attached to opposite second end portion 38 of ankle section 34. Yaw rotatable member 60 has lower perimetrical edge 60A, the purpose of which is discussed in the ensuing description. Yaw rotation mechanism 58 includes yaw drive device 61 and gear 62. Gear 62 is attached to the shaft of yaw drive device 61. Yaw drive device 61 is attached to yaw rotatable member 60 such that gear 62 extends through opening 63 in yaw rotatable member 60. In one embodiment, yaw drive device 61 is the commercially available 26 RPM Premium Planetary Gear Motor (Part No. 638242) manufactured by Servocity of Winfield, KS. Yaw rotatable member 60 includes cylindrical mount 64 that has an interior region 64A. End portion 38 of ankle section 34 is positioned within interior region 64A and held in place with fasteners. Yaw drive device 61 is configured to receive command signals from electronic control module 250. Absolute magnetic rotational position encoder 65 is attached to yaw rotatable member 60 and is discussed in detail in the ensuing description. Yaw rotation mechanism 58 further includes ball bearing 66 that has an inner race 66A and an outer race (not shown). Perimetrical edge 60A of yaw rotatable member 60 is press fit into inner race 66A such that yaw rotatable member 60 may rotate upon ball bearing 66. In one embodiment, ball bearing 66 is the commercially available 1600 Series Non-Flanged Ball Bearing (Part No. 535030) manufactured by Servocity of Winfield, KS. Yaw rotation mechanism 58 further comprises ring gear 67 that has a plurality of teeth 67A and upper portion 67B that extends about teeth 67A. Upper portion 67B is press fit into the outer race (not shown) of ball bearing 66. Gear 62 of yaw drive device 61 engages teeth 67A of ring gear 67 such that rotation of gear 62 causes rotation of yaw rotatable member 60. This configuration allows yaw rotatable member 60 to rotate 360°. Ring gear 67 includes a plurality of equidistantly spaced arms 67C. Each arm 67C extends to a distal end portion 67D which is configured with through-hole 67E that is sized for receiving a fastener (e.g., screw) that fastens or attaches ring gear 67 to petals 54 of alignment member 52. Yaw rotation mechanism 58 further comprises magnet support member 68 that is attached to the underside of ring gear 67. Reference magnets 69 are attached to magnet support member 68. Encoder 65 senses the position of yaw rotatable member 60 with respect to the magnets 69 and outputs electronic signals that represent an absolute position value of yaw rotatable member 60. Electronic control module 250 receives and processes the electronic signals provided by encoder 65.

Referring to FIGS. 1-4, robot 10 further comprises ankle joint module 70 that is attached to second opposite end portion 22 of leg 18. The construction and configuration of ankle joint module 70 is identical to that of ankle joint module 32 which is described in detail in the ensuing description. Robot 10 further comprises ankle section 72 which has first end portion 74 and opposite second end portion 76. First end portion 74 of ankle section 72 is engaged to ankle joint module 70. Ankle joint module 70 is configured to provide ankle section 72 with a single degree of freedom as a pitch rotation thereby allowing ankle section 72 to be raised and lowered. Ankle joint module 70 further comprises a drive system that raises and lowers second ankle section 72 upon receiving command signals from electronic control module 250. The drive system of ankle joint module 70 is identical to the drive system of ankle joint module 32 and is described in detail in the ensuing description.

Referring to FIGS. 1 and 2A, robot 10 further comprises foot module 80 that is attached to opposite second end portion 76 of ankle section 72. Foot module 80 comprises alignment member 82 that has a plurality of petals 84. Support member 85 is attached to petals 84 so as to provide structural support and enhance structural integrity. Support member 85 has the same structure as support member 57 of foot module 50 (see FIG. 2B). Petals 84 are configured to allow alignment member 82 to passively self-align itself upon a voxel as foot module 80 makes initial contact with the voxel. Foot module 80 further comprises a plurality of gripper devices 86 that are attached to alignment member 82. Gripper members 86 have the same configuration and function as gripper devices 56 that were discussed in the foregoing description. Gripper devices 86 receive control signals from electronic control module 250. When alignment member 82 becomes positioned upon and aligned with a voxel, electronic control module 250 outputs control signals that control gripper devices 86 to grab onto the voxel. When it is time to release the voxel, electronic control module 250 issues command signals to gripper devices 86 to release the voxel. In one embodiment, there are four equidistantly spaced gripper devices 86.

Foot module 80 includes yaw rotation mechanism 88 that is mounted to alignment member 82. Yaw rotation mechanism 88 has the same construction and configuration as yaw rotatable mechanism 58 that was described in detail in the foregoing description. Yaw rotation mechanism 88 comprises yaw rotatable member 90 that is configured for yaw rotation and is attached to opposite second end portion 76 of ankle section 72. Yaw rotatable member 90 is able to rotate 360°. Yaw rotation mechanism 88 includes yaw drive device 92 that is engaged with yaw rotatable member 90 and configured to receive command signals from electronic control module 250 that prompt yaw drive device 92 to drive yaw rotatable member 90. Yaw rotatable member 90 is rotatably mounted on ball bearing 93. Ball bearing 93 is engaged with the top portion of ring gear 94. Ball bearing 93 and ring gear 94 have the same construction and configuration as ball bearing 66 and ring gear 67, respectively, that are shown in FIG. 5. Yaw rotation mechanism 88 also includes an absolute magnetic rotational position encoder (not shown) and a magnet support member (not shown) that have the same configuration and function as encoder 65 and magnet support member 68, respectively, shown in FIG. 5. The magnet support member of yaw rotation mechanism 88 has attached thereto a plurality of reference magnets (not shown). The encoder (not shown) on yaw rotatable member 90 senses the position of yaw rotatable member 90 with respect to the reference magnets and outputs electronic signals for processing by electronic control module 250.

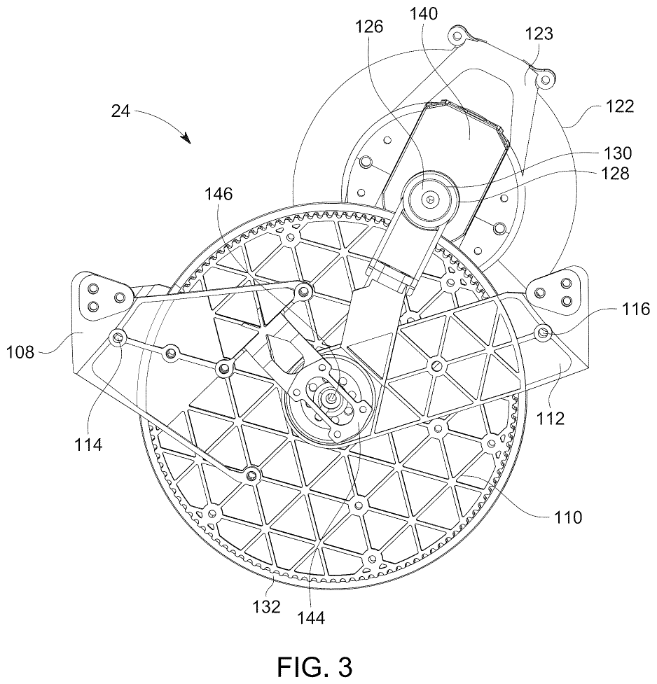

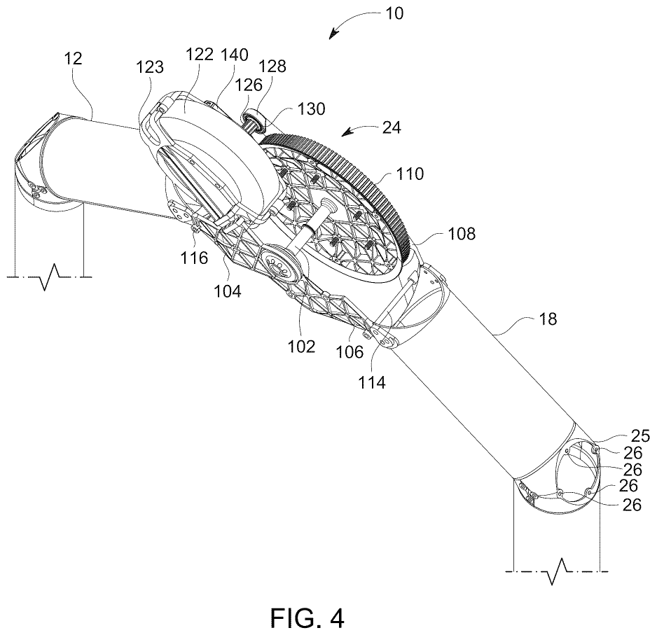

Referring to FIGS. 1, 2A and 3, knee joint module 24 is now described in detail. In order to facilitate understanding of the configuration of knee joint module 24, FIG. 3 shows only knee joint module 24 without any other portions of robot 10. Knee joint module 24 comprises drive yoke member 104 which has one end attached to leg 12 and an opposite end engaged with a first end of output axle 102. Knee joint module 24 includes drive yoke member 106 which has one end attached to leg 18 and opposite end engaged with the first end of output axle 102. As shown in FIG. 2A, drive yoke member 106 is positioned inside of drive yoke member 104. Knee joint module 24 further includes non-drive yoke member 108 which is located on the opposite side of knee joint module 24 (see FIG. 2A) and attached to toothed pulley 110. Pulley 110 is further discussed in the ensuing description. Knee joint module 24 also includes non-drive yoke member 112 which is located on the opposite side of knee joint module 24 (see FIG. 3) and has one end attached to leg 12. The opposite end of non-drive yoke member 112 has an opening therein for receiving a portion of output axle 102. As shown in FIG. 4, bolted stiffening bridge 114 is attached to drive yoke member 106 and non-drive yoke member 108 so as to provide structural support and enhance structural integrity. Bolted stiffening bridge 116 is attached to drive yoke member 104 and non-drive yoke member 112 and has the same structure and configuration as bolted stiffening bridge 114. Bolted stiffening bridge 116 also provides structural support and enhances structural integrity. For purposes of simplifying the view in FIG. 2A, bolted stiffening bridges 114 and 116 are not shown.

Referring to FIGS. 1-4, the drive system of knee joint module 24 comprises pulley 110 which is attached to output axle 102 such that rotation of pulley 110 causes rotation of output axle 102. Motor 122 is mounted within motor bracket 123. Motor bracket 123 is attached to drive yoke member 104. Motor 122 receives electrical power from tethered power line 124 and control signals from electronic control module 250. In an embodiment, motor 122 is a brushless DC motor (a.k. a. BLDM). One suitable commercially available BLDM is the SunnySky M8 Pro Brushless Motor (Part No. 20161226) manufactured by SunnySky USA LLC of Columbus, OH. Toothed drive shaft pulley 126 is mounted or attached to the shaft of motor 122 such that rotation of the motor shaft rotates pulley 126. Pulley 126 is supported by drive line pillow block member 128 that contains block bearing 130. Block bearing 130 engages and allows rotation of pulley 126. Knee joint module 24 includes toothed timing belt 132. In order to facilitate viewing of other components of robot 10, toothed timing belt 132 is not shown in FIGS. 2A and 4. Timing belt 132 engages the toothed portions of pulley 110 and pulley 126. In an embodiment, timing belt 132 is the commercially available high-strength ultra-quiet timing belt (Part No. 7947K789) manufactured by McMaster-Carr of Sante Fe Springs, CA. Rotation of the shaft of motor 122 causes rotation of pulley 126. Since timing belt 132 is engaged with pulleys 110 and 126, rotation of pulley 126 causes rotation of pulley 110. As a result of this configuration, counterclockwise rotation of the motor shaft causes pulley 110 to rotate counterclockwise and lift leg 18, and clockwise rotation of the motor shaft causes pulley 110 to rotate clockwise and lift leg 12.

Referring to FIG. 3, the drive system of knee joint module 24 further includes relative position encoder 140 that is attached to motor bracket 123 and located on the motor shaft so as to monitor shaft position. Relative position encoder 140 outputs signals that correspond to the rotation of the motor shaft. Electronic control module 250 receives and processes these electronic signals to determine the position of the motor shaft and thus, the position of legs 12 and 18. The drive system of the knee joint module 24 further includes an absolute magnetic rotational position encoder assembly that comprises bracket 144 and absolute magnetic rotational position encoder 146. Bracket 144 is attached to pulley 110 and encoder 146 is mounted to bracket 144. Encoder 146 is engaged with an end of output axle 102. Encoder 146 outputs electronic signals that represent an absolute position value of pulley 110. Electronic control module 250 receives and processes the electronic signals provided by encoder 146 in order to determine the position of legs 12 and 18.

Referring to FIG. 1, the configurations of ankle joint modules 32 and 70 are identical to the configuration of knee joint module 24. As described in the foregoing description, end portion 38 of ankle section 34 is fitted inside interior region 64A of cylindrical mount 64 of yaw rotatable member 60. Ankle joint module 32 comprises non-drive yoke member 150 that is attached to end portion 36 of ankle section 34 and is also attached to toothed pulley 152. Non-drive yoke member 154 has the same configuration as non-drive yoke member 112 of knee joint module 24 (see FIG. 3). One end of non-drive yoke member 154 is attached to end portion 16 of leg 12. The opposite end of non-drive yoke member 154 has an opening to receive an end of output axle 156. Ankle joint module 32 includes two drive yoke members that are on the opposite side of ankle joint module 32 and are therefore not shown. One of the aforesaid drive yoke members is identical to drive yoke member 104 of knee joint module 24 and has one end attached to end portion 16 of leg 12 and an opposite end having an opening for receiving the opposite end of output axle 156. The second drive yoke member (not shown) of ankle joint member 32 has the identical configuration as drive yoke member 106 of joint knee module 24 and has one end attached to end portion 36 of ankle section 34 and the opposite end engaged with an end of output axle 156. Ankle joint module 32 includes bolted stiffening bridges 160 and 162 that have the same configuration and perform the same function as bolted stiffening bridges 114 and 116. The drive system of ankle joint module 32 comprises toothed pulley 152 and motor 164. Pulley 152 is attached to the output axle 156 such that rotation of pulley 152 causes rotation of output axle 156. Motor 164 is mounted within motor bracket 165 and is identical to motor 122 of knee joint module 24. Motor bracket 165 is attached to one of the drive yoke members that is located on the other side of ankle joint module 32. Motor 164 receives electrical power from tethered power line 124 and control signals from electronic control module 250. The drive system of ankle joint module 32 further comprises toothed drive shaft pulley 168 that is mounted or attached to the shaft of motor 164 such that rotation of the motor shaft rotates pulley 168. Pulley 168 is supported by drive line pillow block member 170 that contains a block bearing that performs the same function as block bearing 130 of drive line pillow block member 128 of knee joint module 24. Toothed timing belt 172 engages the toothed portions of pulley 152 and pulley 168. Toothed timing belt 172 is identical to toothed timing belt 132 of knee joint module 24. Rotation of the shaft of motor 164 causes rotation of pulley 168. Since timing belt 172 is engaged with pulleys 152 and 168, rotation of pulley 168 causes rotation of pulley 152. As a result of this configuration, counterclockwise rotation of the motor shaft causes counterclockwise rotation of pulley 152 thereby pivoting foot module 50 in the counterclockwise direction. Clockwise rotation of the motor shaft causes clockwise rotation of pulley 152 thereby pivoting foot module 50 in the clockwise direction. The drive system of ankle joint module 32 further includes relative position encoder 174 that is attached to motor bracket 165 and located on the motor shaft so as to monitor shaft position. Relative position encoder 174 is identical to relative position encoder 140 of knee joint module 24 and outputs signals that correspond to the rotation of the motor shaft. Electronic control module 250 receives and processes these electronic signals to determine the position of the motor shaft and thus, the position of foot module 50. The drive system of the ankle joint module 32 further includes an absolute magnetic rotational position encoder assembly that comprises bracket 176 and an absolute magnetic rotational position encoder (not shown) that is identical to and provides the same function as absolute magnetic rotational position encoder 146 of knee joint module 24. FIG. 1 does not show the encoder attached to bracket 176 in order to provide a view of the end of output axle 156. Bracket 176 is attached to pulley 152 and is identical to bracket 144 of the absolute magnetic rotational position encoder assembly of knee joint module 24. The absolute magnetic rotational position encoder of ankle joint module 32 outputs electronic signals that represent an absolute position value of pulley 152. These signals are processed by electronic control module 250.

Referring to FIG. 1, ankle joint module 70 is identical to ankle joint module 32. Therefore, ankle joint module 70 is only briefly described. Ankle joint module 70 includes drive yoke members 180 and 182 that perform the same function and are mounted in the same manner as drive yoke members of ankle joint module 32. Yoke members 180 and 182 have openings sized to receive an end of output axle 183. Ankle joint module 70 also includes a pair of non-drive yoke members (not shown) that are on the reverse side of ankle joint module 70 and which perform the same functions and are mounted in the same manner as the non-drive yoke members 150 and 154 of ankle joint module 32. Ankle joint module 70 further includes bolted stiffening bridges 170 and 172 that perform the same function as bolted stiffening bridges 160 and 162, respectively, of ankle joint module 32. The drive system of ankle joint module 70 is identical to the drive system of ankle joint module 32 and comprises motor 184 which is mounted to bracket 186. Bracket 186 is attached to drive yoke member 182. Motor 184 is identical to and performs the same function as motor 164 of ankle joint module 32. The drive system of ankle joint module 70 further comprises toothed pulley 188 and timing belt 190 that perform the same functions as toothed pulley 152 and timing belt 172, respectively, of ankle joint module 32. Timing belt 190 engages a toothed drive shaft pulley (not shown) that is on the reverse side of ankle joint module 70 and which performs the same function as toothed drive shaft pulley 168 of ankle joint module 32. The toothed drive shaft pulley (not shown) of ankle joint module 70 is supported by a drive line pillow block (not shown) and a block bearing (not shown) that perform the same functions as drive line pillow block 170 and the corresponding block bearing, respectively, of ankle joint module 32. Motor 184 receives electrical power from tethered power line 124 and also receives control signals from electronic control module 250. Motor 184, pulley 188, the drive shaft pulley (not shown) and timing belt 190 cooperate to pivot foot module 80 in the clockwise or counterclockwise directions. The drive system of ankle joint module 70 further comprises a relative position encoder (not shown) and an absolute magnetic rotational position encoder (not shown) that perform the same functions as the relative position encoders and absolute magnetic rotational position encoders used in knee joint module 24 and ankle joint module 32.

Referring to FIGS. 1 and 4, in some embodiments, robot 10 includes cargo holder assembly 96. Cargo holder assembly 96 comprises adapter 97 that is removably attached to section 25 of leg 18. Section 25 includes thru-holes 26 that are sized for receiving fasteners (not shown) that removably fasten or attach adapter 97 to section 25. Cargo holder assembly 96 further includes alignment member 98 which comprises a plurality of petals 99. Alignment member 98 has substantially the same structure as alignment members 50 and 80 discussed in the forgoing description. Alignment member 98 passively aligns itself on a voxel. Cargo holder assembly 98 further comprises gripper device 100 which receives command signals from electronic control module 250 that cause gripper device 100 to grasp or release a voxel. In order to facilitate viewing other features of robot 10, cargo holder assembly 98 is not shown in FIGS. 2A and 4.

Gripper devices 56, 86 and 100 all have the same construction, configuration and mode of operation. Therefore, only gripper device 56 is described in detail. Referring to FIGS. 1 and 2A, each gripper device 56 comprises frame 200 and drive device 202 that is located within and mounted to frame 200. Claw support member 204 is attached to frame 200. Claws 206 are movably attached to claw support member 204 and are engaged with drive device 202. Drive device 202 receives command signals from electronic control module 250 that prompt drive device 202 to engage claws 206 in order to grasp or release a voxel. In an embodiment, drive device 202 is a commercially available D89MW, 32-Bit, Wide Voltage, Metal Gear Servo, manufactured by Hotec RCD USA, Inc. of San Diego, CA. Each gripper device 56, 86 and 100 includes a servo connector board (see FIG. 6) that receives command signals from electronic control module 250 and feeds such command signals to the servo.

Electronic control module 250 is in electronic signal communication with gripper devices 56, 86 and 100, yaw drive devices 61 and 92, the drive systems of knee joint module 24 and ankle joint modules 32 and 70 and all absolute encoders. Tethered power line 124, partially shown in FIG. 1, provides electrical power to the controller boards of electronic control module 250 (see FIG. 6). As will be described in the ensuing description, the aforementioned controller boards include voltage regulation circuitry that provides the appropriate voltages to gripper devices 56, 86 and 100, yaw drive devices 61 and 92 and the drive systems of knee joint module 24 and ankle joint modules 32 and 70. An exemplary embodiment of electronic control module 250 is shown in FIG. 6. Electronic control module 250 provides power and data distribution and comprises three identical controller boards 251, 252 and 253, with all actuators and sensors divided between them. In some embodiments, each controller board 251, 252 and 253 comprises an ESP32 microcontroller with integrated Wi-Fi electronic circuitry. Each ESP32 microcontroller communicates independently with central control system 280 (i.e., base station) using WiFi. The ESP32 microcontroller is a dual-core micro-controller wherein one core is dedicated to handling WiFi communication while the other core controls actuators and processes sensor data in real-time. Each controller board 251, 252 and 253 is designed to control any two brushless DC motors and three servos. Each controller board 251, 252 and 253 has three voltage regulators to handle its power. Different voltage busses exist for the brushless DC motors, servos and the controller board. Specifically, the DC brushless motors of the yaw drive devices and the servos of the gripper devices are powered by 18 VDC that is provided by the voltage regulators on controller boards 251, 252 and 253. Each controller board 251, 252 and 253 includes a voltage monitoring circuit that is configured to disable actuator power upon detection of a voltage drop from the input source. Controller boards 251, 252 and 253 further include two current sensors that monitor the current draw by the servos. Controller boards 251, 252 and 253 read the absolute encoder signals through I² protocol. Power bus 254 carries 18 VDC and is daisy-chained between controller boards 251, 252 and 253. Controller board 251 provides electrical signals to servo connector board 255 which is electrically connected to gripper device 56 which was described in the foregoing description. Controller board 21 also provides electrical signals to yaw drive device 61 which was described in the foregoing description. Controller board 251 also reads all encoder signals from absolute magnetic rotational encoder 65 which was described in the foregoing description. Controller board 252 provides electrical signals to servo connector board 256 which is electrically connected to gripper device 100. Gripper device 100 was described in the foregoing description. Controller board 252 also reads all encoder signals from the absolute magnetic rotational encoders of ankle joint modules 32 and 70. Controller board 253 provides electrical signals to servo connector board 257 which is electrically connected to gripper device 86. Gripper device 86 was described in the foregoing description. Controller board 253 also provides electrical signals to yaw drive device 92 which was discussed in the foregoing description. Controller board 253 reads all encoder signals from absolute magnetic rotational encoder 146 of knee joint module 24 and the absolute magnetic rotational encoder of ankle joint module 70. Each controller board 251, 252 and 253 communicates with central control system 280 (i.e., base station) separately. Controller boards 251, 252 and 253 are in electronic signal communication with each other via GPIOs (General Purpose Input/Output) in order to synchronize both the robot start-motions (“Motion Sync”) and fault alerts (“Fault Sync”). Controller board 251 functions as the leader among the three controller boards, deciding when to send the robot start-motions and fault alerts to the other two follower controller boards 252 and 253. All three controller boards 251, 252 and 253 have substantially identical firmware architecture, except for the portions of the firmware architecture that pertain to the processing of “Motion Sync” and “Fault Sync” information.

Electronic control module 250 further comprises motor controller boards 260 and 261. Motor controller board 260 controls motor 164 of ankle joint module 32 and motor 184 of ankle joint module 70. Motor controller board 261 controls motor 122 of knee joint module 24. In this embodiment, motor controller boards 260 and 261 provide 48 VDC to each motor 122, 164 and 184. Power bus 262 carries 48 VDC and is daisy-chained between motor controller boards 260 and 261. Relative position encoder 174 of ankle joint module 32 and the relative position encoder of ankle joint module 70 are directly connected to motor controller board 260. Similarly, relative position encoder 140 of knee joint module 24 is directly connected to motor controller board 261. In one embodiment, each motor controller board 260 and 261 is a commercially available ODrive v.3.6 Brushless Servo Dual BLDC Motor Controller manufactured by ODrive Robotics of El Sobrante, CA. The ODrive v3.6 motor controller includes an on-board absolute on-axis magnetic encoder and a UART (Universal Asynchronous Receiver/Transmitter) interface. Electronic control module 250 further comprises digital isolators 270 and 272. Digital isolator 270 is connected between controller board 252 and motor controller board 260 so as to prevent ground loops. Similarly, digital isolator 272 is connected between controller board 253 and motor controller board 261 so as to prevent ground loops. Controller board 252 is in electronic signal communication with the UART interface of motor controller board 260. Similarly, controller board 253 is in electronic signal communication with the UART interface of controller board 261. Power bus 273 carries 5 VDC and is daisy-chained between controller board 252 and digital isolator 270 and between digital isolator 270 and motor controller board 260. Similarly, power bus 274 carries 5 VDC and is daisy-chained between controller board 253 and digital isolator 272 and between digital isolator 272 and motor controller board 261.

Ferrite rings (not shown) are added to the harness of each BLDM motor to reduce capacitively coupled noise. Shielded cables are used on the harnesses of all the absolute and relative position encoders to mitigate EMI noise from the BLDM motors.

In other embodiments, communication between controller boards 251, 252 and 253 and central control system 280 (i.e., the base station) may be realized by Ethernet, Bluetooth™, BLE, high-frequency systems (e.g., 900 MHz, 2.4 GHz and 5.6 GHz communication systems), infrared, TCP/IP, HTTP, BitTorrent™, FTP, RTP, RTSP, SSH, any communications protocol that may be used by wireless and cellular telephones, and any other communications protocol, or any combination thereof.

Referring to FIG. 7, illustrates central control system 280 in accordance with an embodiment of the present disclosure. Central control system 280 functions as a base station. Central control system 280 comprises memory medium 282, processor 284 and telemetry circuitry 286. Processor 284 is in electronic signal communication with memory medium 282 and telemetry circuitry 286. Memory medium 282 may be configured as non-transitory computer readable storage medium, computer system memory or random-access memory, such as DRAM, DDR RAM, SRAM, SDRAM, EDO RAM, Rambus RAM and non-volatile memory. In some embodiments, memory medium 282 includes a read-only-memory (ROM). Memory medium 282 may also include cache memory, which may be one or more different types of memory used for temporarily storing data for electronic device applications. Memory medium 282 may store program instructions, code and/or algorithms (e.g., embodied as computer programs) that may be executed by processor 284. Processor 284 may be configured as an ASIC (Application Specific Integrated Circuit), portions or circuits of individual processor cores, entire processor cores, individual processors, central processing units (CPU), signal processors having analog-to-digital conversion (ADC) circuitry and programmable hardware devices such as field programmable gate array (FPGA). Processor 284 is programmed to execute operation software application 290. Operations software application 290 may include, but is not limited to, one or more operating system applications, firmware applications or other suitable applications that enable complete control and monitoring of all mobile robots 10 prior to and during the build-process. Central control system 280 generates commands that are processed by electronic control module 250. The build-plan for a particular 3D-lattice structure is loaded into operations software 290 via data input module 288 and user interface 292. Operations software 290 generates robotic-motion commands that are transmitted to each mobile robot by telemetry circuitry 286. The robotic-motion commands define the type and sequence of robotic motions that must be executed by the robots in order to implement the build-plan. Operations software 290 contains an algorithm that generates the “build order” and optimizes robot motions for build-time efficiency and avoidance of robot collisions. The algorithm implements inverse kinematic trajectory planning in order to achieve the desired positions of the mobile bipedal robot and includes a complete definition of motion/routine hierarchies in order to cover all required activities. The inverse kinematic trajectories used to achieve each of the desired positions of robot 10 are optimized for efficient use of power and torque. Electronic control module 250 processes all robotic-motion commands received from central control system 280 thereby enabling electronic control module 250 to control the operational modes and robotic-motions of robot 10 to ensure safe and functional locomotion and accurate placement of voxels. Prior to and during the build-process, electronic control module 250 constantly transmits telemetry signals that provide the status of the robots. These telemetry signals provide information about battery status, current flow through the circuitry of electronic control module 250, encoder feedback, gripping status, robot foot location and target commands (i.e., target position for voxel placement). These telemetry signals are received and processed by central control system 280 for purposes of fault monitoring and to monitor the build-process.

The particular configurations of knee joint module 24 and ankle joint modules 32 and 70 are optimized to allow robot 10 to efficiently locomote across the 3D-lattice structure under construction and precisely orient alignment member 98 of cargo holder assembly 96 in order to pass a voxel to another robot. Robot 10 is constantly providing status signals to central control system 280 via upstream and downstream telemetry for all motion axes. Knee joint module 24 and ankle joint modules 32 and 70 allow robot 10 to locomote horizontally across the 3D-lattice structure by any one of a several different gaits. One gait is referred to herein as the “inchworm gait”. Another gait is referred to herein as the “step-rotation gait”. The particular configurations of knee joint module 24 and ankle joint modules 32 and 70 also allow vertical movement of robot 10 such that robot 10 may step up to an upper level of the 3D-lattice structure and may step down from an upper level of the 3D-lattice structure.

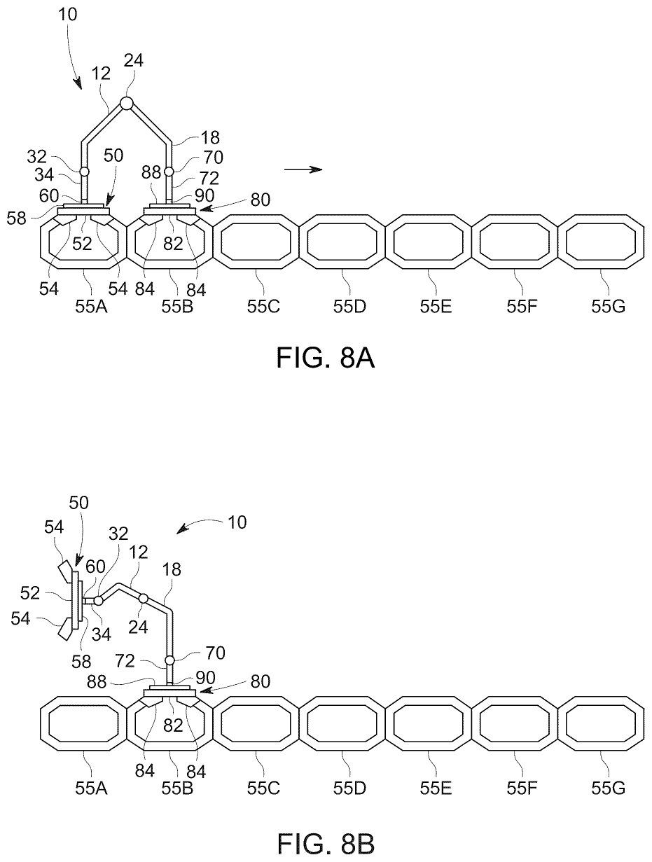

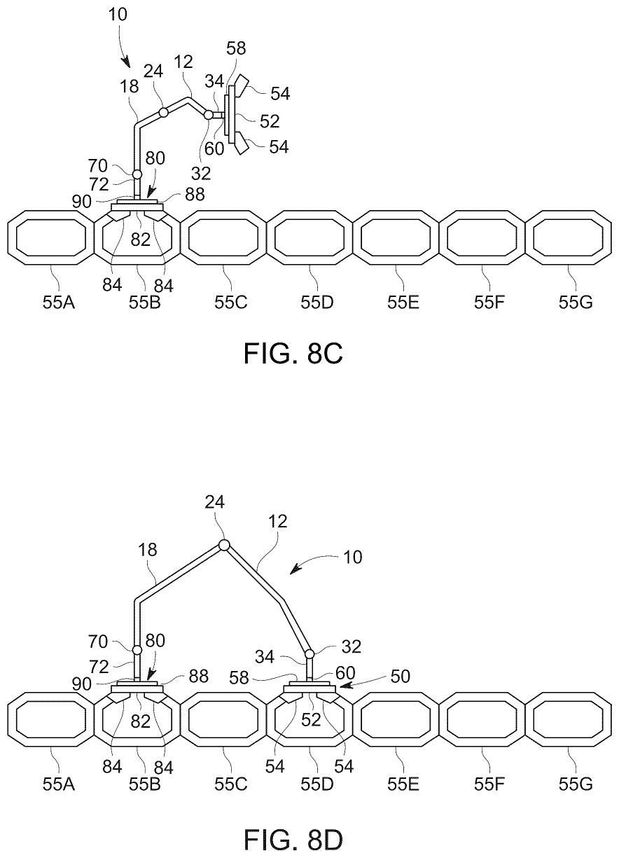

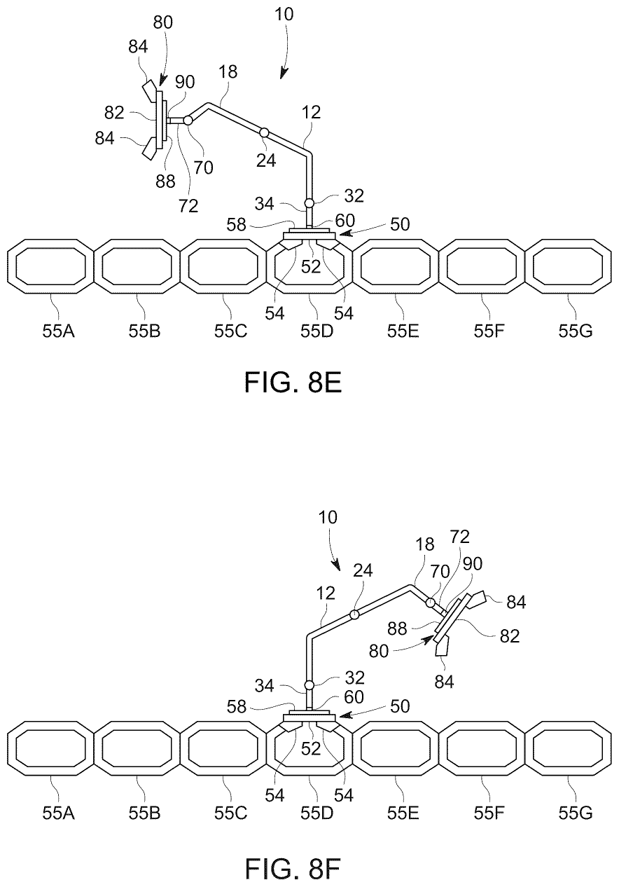

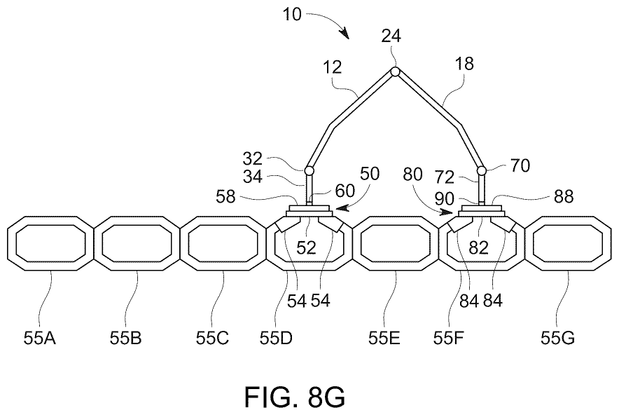

In order to further illustrate the versatility of robot 10, the “step-rotation gait” is now described with reference to FIGS. 8A-8G. The views of the drawings in FIGS. 8A-8G are simplified and do not show many of the components discussed in the foregoing description. This is done in order to facilitate understanding of the “step-rotation gait” mode of locomotion. In the “step-rotation gait”, robot 10 locomotes across a 3D-lattice structure by a series of steps and rotations. In FIG. 8A, leg 12 and leg 18 are initially positioned on voxels 55A and 55B, respectively. Accordingly, central control system 280 provides commands to electronic control module 250 via telemetry to implement the following steps:
a) control the drive system of knee joint module 24 to raise leg 12 (see FIG. 8B);
b) control yaw drive device 92 to rotate yaw rotatable member 90 either clockwise or counterclockwise 180° (see FIG. 8C);
c) thereafter, simultaneously control the drive system of knee joint module 24 to lower leg 12 and control the drive system of ankle joint module 32 to pivot ankle section 34 clockwise in the pitch rotational direction so that alignment structure 52 becomes aligned with and positioned upon voxel 55D (see FIG. 8D);
d) control gripper devices 56 so that claws 206 grab onto voxel 55D in order to stabilize robot 10 prior to the next rotation;
e) control the drive system of knee joint module 24 to raise leg 18 (see FIG. 8E);
f) control yaw drive device 61 to rotate yaw rotatable member 60 either clockwise or counterclockwise 180° (see FIG. 8F);
g) thereafter, simultaneously control the drive system of knee joint module 24 to lower leg 18 and control the drive device of ankle joint module 70 to pivot ankle section 72 in the pitch rotational direction so that alignment structure 82 becomes aligned with and positioned upon voxel 55F (see FIG. 8G);
h) control gripper devices 86 so that its claws grab onto voxel 55F in order to stabilize robot 10 prior to the next rotation; and
i) repeat the above steps until robot 10 is at the desired location.

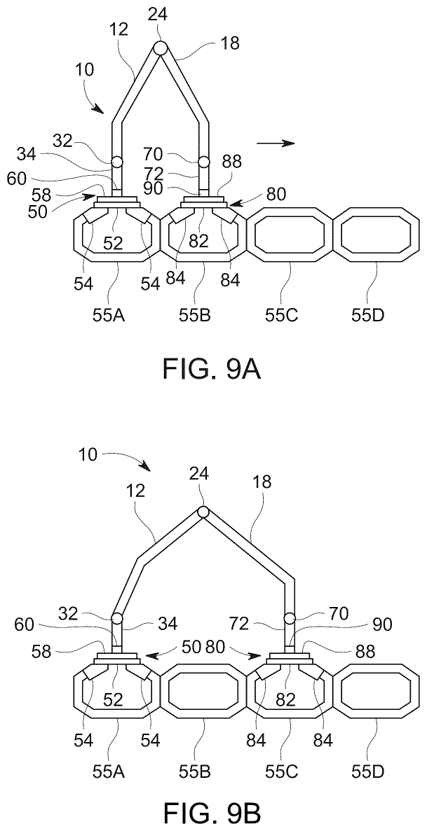

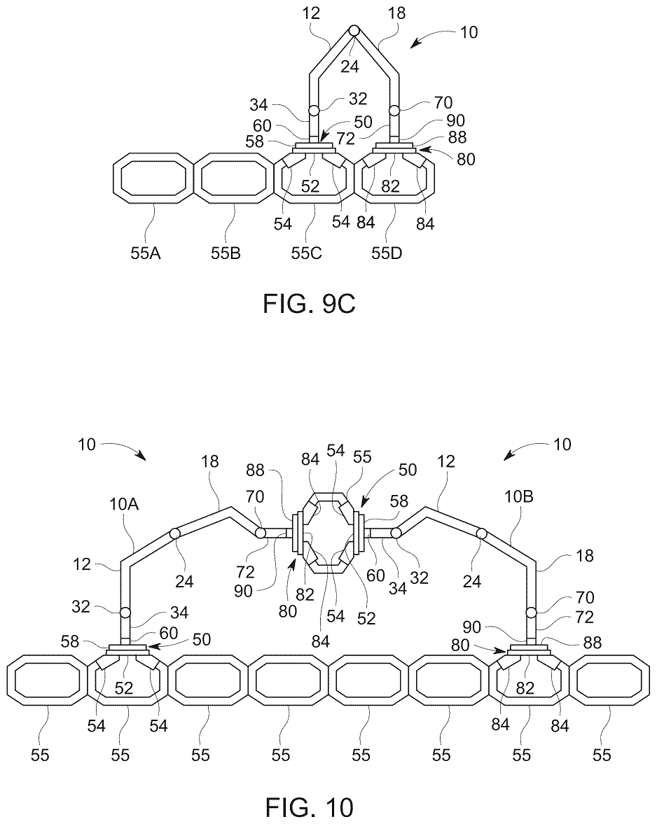

As an example, the “inchworm gait” is now described with reference to FIGS. 9A-9C. The views of the drawings in FIGS. 9A-9C are simplified and do not show many of the components discussed in the foregoing description. This is done in order to facilitate understanding of the “inchworm gait” mode of locomotion The 3D-lattice structure comprises a plurality of voxels indicated by reference numbers 55A-G. As shown in FIG. 9A, robot 10 is currently positioned such that leg 12 is positioned upon voxel 55A and leg 18 is positioned upon voxel 55B. In an exemplary embodiment, central control system 280 outputs command signals to electronic control module 250 which, in response, generates command signals to the drive systems of knee joint module 24 and ankle joint modules 32 and 70 in order to move robot 10 in accordance with an “inchworm gait”. Accordingly, processor 284 of central control module 280 may be programmed to generate commands to electronic control module 250 for implementing the following steps:
a) control the drive system of knee joint module 24 to raise leg 18;
b) control the drive system of ankle joint module 32 to pivot leg 12 clockwise in the pitch rotational direction in order to allow foot module 80 of leg 18 to become positioned over voxel 55C;
c) control the drive system of ankle joint module 70 to pivot ankle section 72 in the pitch rotational direction so that alignment structure 82 will be aligned with voxel 55C;
d) control the drive system of knee joint module 24 to lower leg 18 so that alignment structure 82 becomes positioned upon voxel 55C (see FIG. 9B);
e) control the gripper devices 86 of foot module 80 to grasp voxel 55C;
f) control the drive system of knee joint module 24 to raise leg 12;
g) thereafter, control the drive system of knee joint module 24 to pivot leg 12 counterclockwise so that foot module 50 becomes positioned over voxel 55B;
h) thereafter, control the drive system of ankle joint module 32 to pivot ankle section 34 in the pitch rotational direction so that alignment structure 52 becomes aligned with voxel 55B;
i) control the drive system of knee joint module 24 to lower leg 12 so that alignment structure 52 becomes positioned upon and aligned with voxel 55B;
j) control gripper devices 56 of foot module 50 to grasp voxel 55B; and
k) repeat steps (a)-(j) until robot 10 is positioned on the desired voxels 55.

In accordance with another aspect of the present disclosure, a team of mobile robots work together to carry, transfer, place and attach voxels to form a 3D-lattice structure. The team of mobile robots autonomously unpacks and assembles structural unit cells into functioning structures and systems. The team of mobile robots then lives (i.e., remain for extended or undetermined lengths of time) and locomotes on the 3D-lattice structure to monitor the health and performance of the 3D-lattice structure, making repairs and reconfigurations as needed. Each robot in the team has a different role and responsibility. A first robot 10 performs the role of a “voxel depot robot”. A second robot 10 performs the role of a “cargo robot”. A third robot 10 performs the role of a “crane robot”. The voxel depot robot retrieves a voxel from a voxel depot (or voxel loading area) and then transfers the retrieved voxel to the cargo robot. The cargo robot then provides the voxel to the crane robot. The crane robot then positions the voxel at a predetermined location in accordance with the build-plan of the 3D-lattice structure. In some embodiments, a fourth mobile robot (not shown) performs the role of a bolter robot and attaches or bolts the voxels together to provide a stable 3D-lattice structure. The bolter robot is configured to locomote across the faces of the voxels and fasten the voxels together with high-strength low-weight fasteners. An example of such high-strength, light weight fasteners are disclosed in the aforementioned U.S. Pat. No. 11,498,250. The electronic control modules 250 on each robot receives commands from central control system 280.

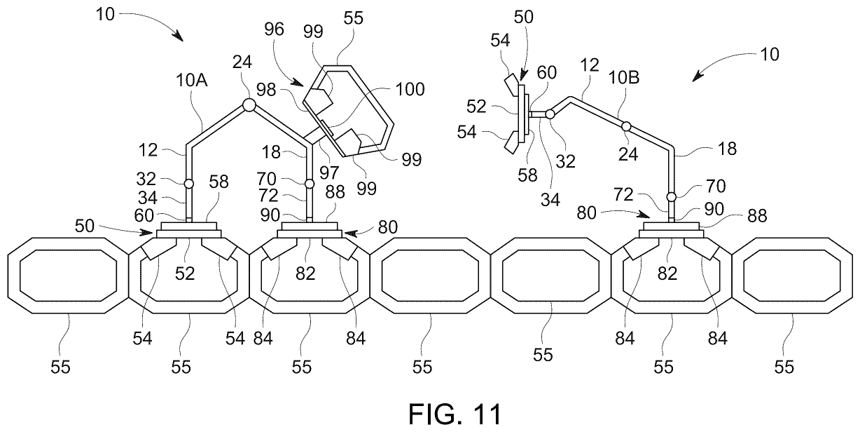

A voxel 55 may be transferred from the cargo robot to the crane robot by any one of several techniques. For example, in FIG. 10, cargo robot 10 (indicated by reference number 10A) is using its foot module 80 to pass voxel 55 to foot module 50 of crane robot 10 (indicated by reference number 10B). In FIG. 11, the voxel 55 is fixtured to alignment member 98 of cargo holder assembly 96 on cargo robot 10A and crane robot 10B is positioned to use its foot module 50 to remove the voxel 55 from alignment member 98. In the scenarios shown in FIGS. 10 and 11, cargo robot 10B does not have a cargo holder assembly 96 since this assembly is not needed for cargo robot 10B to perform its role.

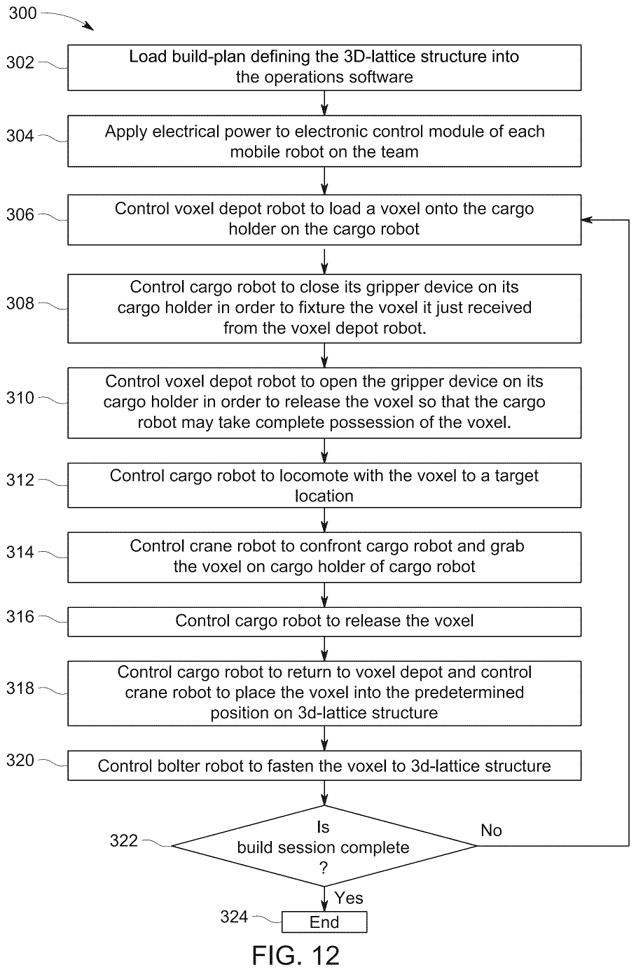

FIG. 12 illustrates method 300 of assembling a 3D-lattice structure using the aforementioned team of robots in accordance with an exemplary embodiment of the present disclosure. Method 300 generally begins at step 302 wherein the build-plan defining the 3D-lattice structure is loaded into the operations software that is programmed into processor 284 of central control system 280. The operations software contains an algorithm that generates the “build order” and optimizes robot motions for build-time efficiency and to avoid robot collisions. Processor 284 executes the operations software so as to generate robotic motion commands required to implement the build-plan. Central control system 280 sends these robotic motion commands to the electronic control module 250 on each robot. Following step 302, the method proceeds to step 304 wherein electrical power is applied to electronic control board of each mobile robot on the team. At step 306, the voxel depot robot loads a voxel onto the cargo holder on the cargo robot. The action described at step 306 may occur at the voxel depot or voxel loading area of the 3D-lattice structure, or at a location where voxels are being removed for reconfiguration. At step 308, the cargo robot closes its gripper device on its cargo holder in order to fixture the voxel it just received from the voxel depot robot. Next, in step 310, the voxel depot robot opens the gripper device on its cargo holder in order to release the voxel so that the cargo robot may take complete possession of the voxel. In step 312, the cargo robot locomotes with the voxel to a target location (e.g., a build-front). Next, in step 314, the crane robot confronts the cargo robot and grabs the voxel on the voxel holder of the cargo robot. In step 316, the cargo robot releases the voxel. After step 316, the method proceeds to step 318 wherein the cargo robot returns to the voxel depot and the crane robot places the voxel into the predetermined position on the 3D-lattice structure. After the voxel is positioned at the predetermined position, the method proceeds to step 320 wherein the bolter robot is controlled to fasten the voxel to the 3D-lattice structure. After the bolter robot fastens the voxel to the 3D-lattice structure, the method proceeds to step 322 wherein it is determined whether the build session has been completed. If the build session is not complete, the method returns to step 306 and repeats steps 306-322. If the build session is complete, then the method ends at step 324. As the actions indicated in steps 306-322 are implemented, the electronic control modules 250 of the robots are constantly transmitting telemetry signals that provide the status of the robots. These telemetry signals provide information about battery status, current flow through the circuitry of electronic control module 250, encoder feedback, target commands, gripping status and robot foot location. These telemetry signals are received and processed by central control system 280 for purposes of fault monitoring and to monitor the build-process.

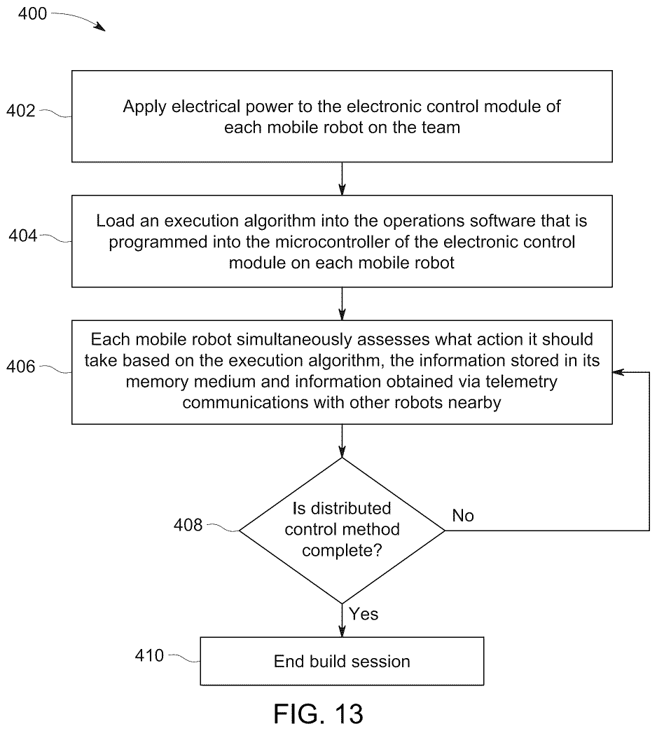

FIG. 13 illustrates distributed control method 400 for a build session wherein two mobile robots are positioned on the 3D-lattice structure in accordance with an embodiment of the present disclosure. Method 400 generally begins at step 402 wherein electrical power is applied to electronic control module 250 of each mobile robot on the team. After electrical power is applied to the mobile robots, the method proceeds to step 404 wherein an execution algorithm is loaded into the operations software that is programmed into controller boards 251, 252 and 253 of electronic control module 250 on each robot. This is accomplished via telemetry signals transmitted by the central control system 280. Next, in step 406, each mobile robot simultaneously assesses what action it should take based on the execution algorithm, the information stored in its memory medium and information obtained via telemetry communications from neighboring robots. Step 408 determines if the distributed control method is complete. If the distributed control method is complete, the method proceeds to step 410 wherein the build-session ends. If the distributed control method is not complete, the method repeats step 406 as many times as is necessary. Once the distributed control method is complete, the build session is ended at step 410. As the actions indicated in steps 402-410 are implemented, the electronic control boards of the robots are constantly transmitting telemetry signals that provide the status of the robot. These telemetry signals provide information about battery status, current flow through the circuitry of electronic control module 250, encoder feedback, target commands, gripping status and robot foot location. These telemetry signals are received and processed by central control system 280 for purposes of fault monitoring and to monitor the build-process.

The mobile bipedal robot of the present disclosure provides many advantages and benefits. For example, a team of mobile bipedal transport robots 10 allows autonomous assembly of functional structures from a set of packed, lightweight building blocks, such as voxels. Voxels are repairable and thus any repairs of the voxels may be accomplished with the mobile bipedal robots thereby eliminating issues with storing and obtaining spare parts. Since the voxels are lightweight and easily attached together and detached from each other, the mobile bipedal robots may easily implement revisions to an original build plan of a structure. A team of a mobile cargo transport robot and mobile crane transport robot may efficiently unpack the voxels and positioned the voxels at predetermined locations in accordance with the build plan. The ability of a team of mobile bipedal robots to “live” on (i.e., remain on for extended or undetermined lengths of time) the structure that is under construction provides a system autonomy that allows leveraging of discrete indexing/local metrology, local error correction and discrete algorithms. Teams of mobile bipedal robots allows the prompt and efficient construction, assembly and servicing of physical systems and terrestrial infrastructure including, but not limited to, habitats, spaceports, solar farms and arrays, communication facilities, antennas and scientific instrumentation. Reductions in the cost-work function are achieved by the particular design of the mobile bipedal robot in combination with the ability of the mobile bipedal robots to work as a team to assemble infrastructure. The particular configurations of the knee joint and the ankle joints are optimized to permit both efficient locomotion of the bipedal robot along the structure under construction and efficient orientations of the cargo gripper for passing and placing voxels. The inverse kinematic trajectories used to achieve each of the target positions of the bipedal robot are optimized for efficient use of power and torque.

The mobile robotic fabrication system and methodologies disclosed herein provide the ability to construct structures larger than the build-envelope of conventional static robotic platforms. Since large scale structures can be decomposed into finite elements, the bipedal robots disclosed herein utilize local sensing, metrology and localization to place the voxels. The global metrology and precision are set by the particular configurations of the knee joint, ankle joints and corresponding drive devices which display well characterized and symmetric error distributions thereby allowing for fidelity or precision that increases as the system increases in size. Passive alignment of the robots and voxels allow local gait error correction to be employed as each step indexes to alignment points on each voxel. Such techniques and methodologies allow continuously scalable and reconfigurable structural opportunities. Use of the mobile bipedal robots to assemble and reconfigure materials and structures from discrete building blocks (e.g., voxels) has the potential to bypass the geometry/performance and/or size (e.g., launch volume) limitations of conventional production methods.

The description of the present disclosure has been presented for purposes of illustration and description, but is not intended to be exhaustive or limited to the disclosure in the form disclosed. In the foregoing description, numerous specific details are set forth to provide a thorough understanding of the embodiments described in this disclosure. However, one having ordinary skill in the art should recognize that the embodiments might be practiced without these specific details. In some instances, well-known structures and techniques have not been shown in detail for ease of illustration and to avoid obscuring the description of the embodiments. It should be emphasized that the above-described embodiments are only non-limiting examples of implementations and were chosen and described in order to best explain the principles of the disclosure. Many modifications and variations will be apparent to those of ordinary skill in the art without departing from the scope and spirit of the disclosure. It is intended that the following claims be interpreted to embrace all such modifications and variations.

What is claimed is:

1. A mobile bipedal robot, comprising:
a knee joint module having a drive system configured to receive control signals;
a pair of leg members comprising a first leg member and a second leg member, wherein each leg member has a first end portion joined to the knee joint module and an opposite second end portion;
wherein the knee joint module is configured allow movement of the leg members in accordance with a single degree of freedom as a pitch rotation and wherein the drive system is configured to receive control signals that prompt the drive system to raise and lower the leg members;
a first ankle joint module joined to an opposite second end portion of the first leg member;
a first ankle section having a first end portion joined to the first ankle joint module and an opposite second end portion;
wherein the first ankle joint module is configured to allow movement of the first ankle section in accordance with a single degree of freedom as a pitch rotation and further includes a drive system configured to receive control signals that prompt the drive system of the first ankle joint module to raise and lower the first ankle section;
a second ankle joint module joined to an opposite second end portion of the second leg member;
a second ankle section having a first end portion joined to the second ankle joint module and an opposite second end portion;
wherein the second ankle joint module is configured to allow movement of the second ankle section in accordance with a single degree of freedom as a pitch rotation and further includes a drive system configured to receive control signals that prompt the drive system of the second ankle joint module to raise and lower the second ankle section;
a pair of foot modules, each of which being joined to a corresponding one of the ankle sections, wherein each foot module comprises:
an alignment member configured to passively self-aligned itself upon a 3D-lattice unit cell,
at least one gripper device attached to the alignment member and configured to receive control signals that prompt the gripper device to grasp the 3D-lattice unit cell, and
a yaw rotation mechanism mounted to the alignment member and having a yaw rotatable member that is configured for yaw rotation, the yaw rotatable member being joined to a corresponding one of the ankle sections, wherein the yaw rotation mechanism includes a yaw drive device that is engaged with the yaw rotatable member and which is configured to receive control signals that prompt the yaw drive device to rotate the yaw rotatable member; and
an electronic control module mounted to one of the leg members and configured for generating the control signals for controlling the gripper devices and yaw drive devices and the drive systems of the knee joint module and the ankle joint modules.

2. The mobile bipedal robot according to claim 1 wherein the electronic control module comprises a plurality of controller boards to generate the control signals.

3. The mobile bipedal robot according to claim 1 wherein the electronic control module includes telemetry circuitry for telemetry communication with a central control system.

4. The mobile bipedal robot according to claim 1 wherein the drive system of the knee joint module comprises a motor having a motor shaft.

5. The mobile bipedal robot according to claim 4 wherein the drive system of the knee joint module further comprises at least one position encoder device for outputting electronic signals that correspond to the position of the motor shaft.

6. The mobile bipedal robot according to claim 5 wherein the electronic control module is configured to process the signals provided by the at least one position encoder.

7. The mobile bipedal robot according to claim 1 wherein the drive system of each ankle joint module comprises a motor having a motor shaft.

8. The mobile bipedal robot according to claim 7 wherein the drive system of each ankle joint module further comprises at least one position encoder device for outputting signals corresponding to the position of the motor shaft.

9. The mobile bipedal robot according to claim 8 wherein the electronic control module is configured to process the signals provided by the at least one position encoder of each ankle joint module.

10. The mobile bipedal robot according to claim 1 wherein the at least one gripper device comprises a plurality of gripper devices that are equidistantly spaced apart.

11. The mobile bipedal robot according to claim 1 wherein the gripper device comprises:
a frame;
a pair of claws movably attached to the frame and configurable to an opened state and to a closed state; and
a servo motor engaged with the pair of claws for configuring the claws to the opened state or to the closed state.

12. The mobile bipedal robot according to claim 1 further wherein each yaw rotation mechanism further comprises:
a magnet support member having attached thereto a plurality of reference magnets;
at least one position encoder attached to the yaw rotatable member and configured to output signals representing the position of the yaw rotatable member with respect to the reference magnets; and
wherein the electronic control module processes the signals outputted by the position encoder to determine a position of the yaw rotatable member.

13. The mobile bipedal robot according to claim 1 further comprising a cargo holder assembly, wherein the cargo holder assembly comprises:
an adapter attached to one of the leg members;
a cargo alignment member configured to passively align itself upon a cargo 3D-lattice unit cell as the cargo alignment member makes contact with the cargo 3D-lattice unit cell; and
at least one gripper device attached to the cargo alignment member and configured to receive control signals that control the gripper device to grab onto or release the 3D-lattice unit cell.

14. The mobile bipedal robot according to claim 13 further comprising means for providing electrical power to the electronic control module, the gripper devices, the yaw drive devices and the drive systems of the knee joint module and ankle joint modules.

15. A mobile bipedal robot, comprising:
a knee joint module having a drive system configured to receive control signals;
a pair of leg members comprising a first leg member and a second leg member, wherein each leg member has a first end portion joined to the knee joint module and an opposite second end portion;
wherein the knee joint module is configured allow movement of the leg members in accordance with a single degree of freedom as a pitch rotation and wherein the drive system is configured to receive control signals that prompt the drive system to raise and lower the leg members;
a first ankle joint module joined to an opposite second end portion of the first leg member;
a first ankle section having a first end portion joined to the first ankle joint module and an opposite second end portion;
wherein the first ankle joint module is configured to allow movement of the first ankle section in accordance with a single degree of freedom as a pitch rotation and further includes a drive system configured to receive control signals that prompt the drive system of the first ankle joint module to raise and lower the first ankle section;
a second ankle joint module joined to an opposite second end portion of the second leg member;
a second ankle section having a first end portion joined to the second ankle joint module and an opposite second end portion;
wherein the second ankle joint module is configured to allow movement of the second ankle section in accordance with a single degree of freedom as a pitch rotation and further includes a drive system configured to receive control signals that prompt the drive system of the second ankle joint module to raise and lower the second ankle section;
a pair of foot modules, each of which being joined to a corresponding one of the ankle sections, wherein each foot module comprises:
an alignment member configured to passively self-aligned itself upon a 3D-lattice unit cell,
at least one gripper device attached to the alignment member and configured to receive control signals that prompt the gripper device to grasp the 3D-lattice unit cell, and
a yaw rotation mechanism mounted to the alignment member and having a yaw rotatable member that is configured for yaw rotation, the yaw rotatable member being joined to a corresponding one of the ankle sections, wherein the yaw rotation mechanism includes a yaw drive device that is engaged with the yaw rotatable member and which is configured to receive control signals that prompt the yaw drive device to rotate the yaw rotatable member; and
a cargo holder assembly attached to one of the leg members and comprising a cargo alignment member configured to passively align itself upon a cargo 3D-lattice unit cell as the cargo alignment member makes contact with the cargo 3D-lattice unit cell, and at least one gripper device attached to the cargo alignment member and configured to receive control signals that control the gripper device to grab onto or release the cargo 3D-lattice unit cell; and
an electronic control module mounted to one of the leg members and comprising controller boards configured to generate the control signals for controlling the gripper devices and yaw drive devices and the drive systems of the knee joint modules and the ankle joint modules, the electronic control module further comprising telemetry circuitry for receiving robotic-motion commands from a central control system.

16. The mobile bipedal robot according to claim 15 wherein the drive system of the knee joint module comprises a motor having a motor shaft.

17. The mobile bipedal robot according to claim 16 wherein the drive system of the knee joint module further comprises at least one position encoder device for outputting signals that correspond to the position of the motor shaft and wherein the electronic control module is configured to process the signals provided by the at least one position encoder.

18. The mobile bipedal robot according to claim 15 wherein the drive system of each ankle joint module comprises a motor having a motor shaft.

19. The mobile bipedal robot according to claim 18 wherein the drive system of each ankle joint module further comprises at least one position encoder device for outputting signals corresponding to the position of the motor shaft and wherein the electronic control module is configured to process the signals provided by the position encoders.

20. The mobile bipedal robot according to claim 15 further wherein each yaw rotation mechanism further comprises:
a magnet support member having attached thereto a plurality of reference magnets;
at least one position encoder attached to the yaw rotatable member and configured to output signals representing the position of the yaw rotatable member with respect to the reference magnets; and
wherein the electronic control module processes the signals outputted by the position encoder to determine a position of the yaw rotatable member.
